(19) United States
(12) Patent Application Publication
(10) Pub. No.: US 2005/0110617 A1
(43) Pub. Date: May 26, 2005

(54) Nurse call interface and method of operation

(76) Inventors: Kevin W. Kile, Ft. Worth, TX (US); Robert F. Sanford, Flower Mound, TX (US); William J. Kanewske III, Southlake, TX (US)

Correspondence Address: GUNN, LEE & HANOR, 700 N. ST. MARY'S STREET, SUITE 1500, SAN ANTONIO, TX, 78205, US

(21) Appl. No.: 10/723,598

(22) Filed: Nov. 25, 2003

(51) Int. Cl. G08B 1/00

(52) U.S. Cl. 340/286.07; 340/686.1; 340/573.4

(57) ABSTRACT

A nurse call interface and method of operation is provided as part of a nurse call interface system which includes a sensor pad for sensing loss of weight thereon. Nurse call interface is powered by a battery which is regulated by a voltage regulator. A microprocessor is provided within nurse call interface connected to an LED, alarm and relay assembly. The relay assembly is connected to a nurse call interface plug which plugs into a nurse call box wall plate. Microprocessor senses voltage changes from sensor pad. If a patient gets off the sensor pad, the loss of weight causes a voltage to exceed 2.5 volts and microprocessor sends a signal to the LED, alarm and relay assembly actuating each. A nurse call button assembly can be provided as part of the nurse call interface system which connects to the nurse call interface. If the button of this assembly is depressed, the LED, alarm, and relay assembly are each actuated.

### BACKGROUND OF THE INVENTION

1. Field of the Invention

Applicant's invention relates to a nurse call interface and method of operation.

2. Background Information

The concept of notifying a nurse call station whenever a patient or resident exits the bed is not new; however, there are several different ways in which this concept can be carried out as is illustrated in the prior art.

U. S. Pat. No. 4,020,482 issued to Feldl disclosed an elongated air bag that was placed under a bed mattress and connected to a pressure actuated electrical switch in a remote location. The switch of this invention is open as long as the patient's weight maintains an air pressure greater than the preset actuating pressure and closes when the patient's weight is removed lowering the pressure. When the pressure is lowered a signal is sent to a remote location. This invention incorporates a pair of pressure plates to increase the surface area sensing the weight change.

In the patent issued to Roberts, U.S. Pat. No. 4,228,426 another monitoring system is disclosed which utilizes a connecting unit attached to a flat pressure activated switching means that is adapted for connection between a nurse call button and a communication panel in a hospital room. With this invention, a pair of electrical conductors indicate when the patient is in the bed. When the pair of electrical conductors is pressed together, a signal is sent indicating the patient is still in the bed.

U.S. Pat. No. 4,539,560 issued to Fleck et al discloses a bed departure detection system that employs tape switch detectors in fixed positions in a bed mattress. In the tape switch system, two resilient metal conductors pressed together indicates the patient is still in bed. The detection system connects with existing nurse call communication links to communicate signals to a nurse call station which indicate when the patient has exited the bed.

In U.S. Pat. No. 4,638,307 issued to Swartout, an apparatus is disclosed that determines when weight has been lifted from a location. This apparatus incorporates a sealed reed switch attached near the bottom of a compressible pad and a magnet attached near the top of the pad. The reed switch is attached in such a way that when the pad is compressed and the magnet is brought into close proximity to the reed switch, the circuit is open and no alarm sounds, but when the weight of compression is removed, the circuit closes and the alarm sounds.

U.S. Pat. No. 5,353,012 issued to Barham et al discloses a detecting apparatus that incorporates an elongated sensor for placement parallel to one axis of a bed. The sensor has two conductive members, one being connected to a power source wherein the weight of a body in the bed urges the conductive members together to define an electrical path. Values are provided concerning position and activity levels such that when these values are exceeded an alarm sounds.

For U.S. Pat. No.5,600,108 issued to Newham, an enclosure is disclosed for mounting a bed monitoring system to a bed frame. This invention does include a sensor mat for determining the presence of the patient.

U.S. Pat. No. 5,844,488 issued to Musick provides for a sensor pad to attaches to the top and across the width of a mattress having a central pressure switch which indicates the presence of a patient in the center of the bed. An early warning signal is attached to an edge switch which is provided to indicate when the patient has moved from the center of the bed to the edge of the bed.

In U.S. Pat. No. 6,025,782, the continuation in part U.S. Pat. No. 6,297,738 issued to Newham, and US 2002/0070866 published Jun. 13, 2002 for Newham, a device for monitoring the presence of a person is disclosed using proximity induced dielectric shift sensing. A control module is provided with a capacitive array which supplies a suitable oscillator driver current and concurrently senses capacitance value changes within the capacitive array induced through dielectric shifts within the array brought about by the presence or absence of the patient's body. When the capacitance changes in this system, a signal is sent to the nurse station.

For U.S. Pat. No.6,417,777 issued to Fitzgerald, et al, a patient monitoring system is disclosed including a pressure sensitive mat that is sealed around its exterior with the interior kept in communication with the atmosphere by way of flexible tubing which encloses an electrical line.

U.S. Pat. No.6,544,200 issued to Smith et al discloses an electronic patient monitor that incorporates a sensor system that automatically configures itself depending on the sensor used and/or the environment in which the monitor is placed. This monitor provides numerous controls that provide warning signals when the weight of the patient is no longer detected in the bed.

Pending U.S. application Publication No. US 2002/0067273 published Jun. 6, 2002 discloses a patient monitor that includes a pressure sensor put under the patient. This sensor provides a normally open switch having two contacts. The closing of these contacts requires bending one of the contacts over a spacing means. In this manner the two contacts are kept apart until the spacing means is forced shut. Pressure on the pad over a preset amount arms the switch and release of the pressure causes an alarm to sound.

The present invention is distinct from the prior art. The present invention is intended to be plugged directly into the nurse call box on the wall in a hospital room. The nurse call interface works in tandem with bed exit and chair exit sensor pads. In this arrangement, if the patient or resident exits the bed or chair, the sensor pad sends a signal to the present nurse call interface. The present nurse call interface in turn converts the normally closed signal of the sensor pad to an opened signal that the nurse call box can monitor.

A microprocessor is provided within the nurse call interface and is connected to an LED, alarm and relay assembly. The relay assembly is connected to a nurse call interface plug which plugs into a nurse call box wall plate. Microprocessor senses voltage changes from sensor pad caused by weight change thereon. If a patient exits the sensor pad, the voltage sensed by microprocessor exceeds 2.5 volts and microprocessor sends a signal to the LED, alarm and relay assembly actuating each. A nurse call button assembly can be provided as part of the nurse call interface system which connects to the nurse call interface. If the button on this assembly is depressed, the LED, alarm, and relay assembly are each actuated. When the relay assembly is actuated, a signal is transmitted to the nurse call station.

### SUMMARY OF THE INVENTION

It is an object of the present invention to provide a novel nurse call interface.

It is another object of the present invention to provide a novel nurse call interface that is designed to be inserted directly into the nurse call box on the hospital room wall.

Still another object of the present invention is to provide a novel nurse call interface that works in a tandem with a bed or chair sensor pad that senses a weight change thereon.

An additional object of the present invention is to provide a novel nurse call interface that is designed to notify the nurse station when the nurse call button is depressed or the patient or resident exits a chair or bed where the sensor pad is located.

Another object of the present invention is to provide a novel nurse call interface that incorporates an opening that is used to accept signals from a sensor pad located in a bed or chair to sense a weight change thereon.

Yet an additional object of the present invention is to provide a novel nurse call interface that incorporates an opening that is used to accept signals from a nurse call button.

Still another object of the present invention is to provide a novel nurse call interface that incorporates a novel electrical assembly for additional nurse call signal.

It is another object of the present invention to provide a novel electrical assembly for the nurse call interface that incorporates a voltage regulator, low voltage comparator, microprocessor, LED, alarm, and relay assembly.

An additional object of the present invention is to provide a novel electrical assembly that incorporates a voltage regulator that converts the battery voltage to a steady voltage for use by the remainder of the nurse call interface.

Yet another object of the present invention is to provide a novel electrical assembly with a low voltage comparator that recognizes when the battery has reached the end of its life.

It is another object of the present invention to provide a novel electrical assembly that has the ability to use existing code or accept new code to use in the system.

In satisfaction of these and related objectives, Applicant's present invention provides a nurse call interface as part of a nurse call interface system which includes a sensor pad to determine if a patient has left a chair or bed. Nurse call interface is powered by a battery which is regulated by a voltage regulator. A microprocessor is provided within the nurse call interface and is connected to an LED, alarm and relay assembly. The relay assembly is connected to a nurse call interface plug which plugs into a nurse call box wall plate. Microprocessor senses voltage changes from sensor pad caused by weight change thereon. If a patient exits the sensor pad, the voltage sensed by microprocessor exceeds 2.5 volts and microprocessor sends a signal to the LED, alarm and relay assembly actuating each. A nurse call button assembly can be provided as part of the nurse call interface system which connects to the nurse call interface. If the button on this assembly is depressed, the LED, alarm, and relay assembly are each actuated.

### BRIEF DESCRIPTION OF THE DRAWINGS

FIG. 1 is a diagrammatic view of the preferred embodiment of the nurse call interface system of the present invention.

FIG. 2 is a perspective view of the components of the preferred embodiment of the nurse call interface system of the present invention.

FIG. 3 is a back view of the preferred embodiment of the nurse call interface of the present invention.

FIG. 4 is a block diagram of the electrical schematic for the preferred embodiment of the nurse call interface of the present invention.

FIG. 5 is a detailed electrical schematic of the preferred embodiment of the nurse call interface of the present invention.

### DETAILED DESCRIPTION OF THE PREFERRED EMBODIMENT

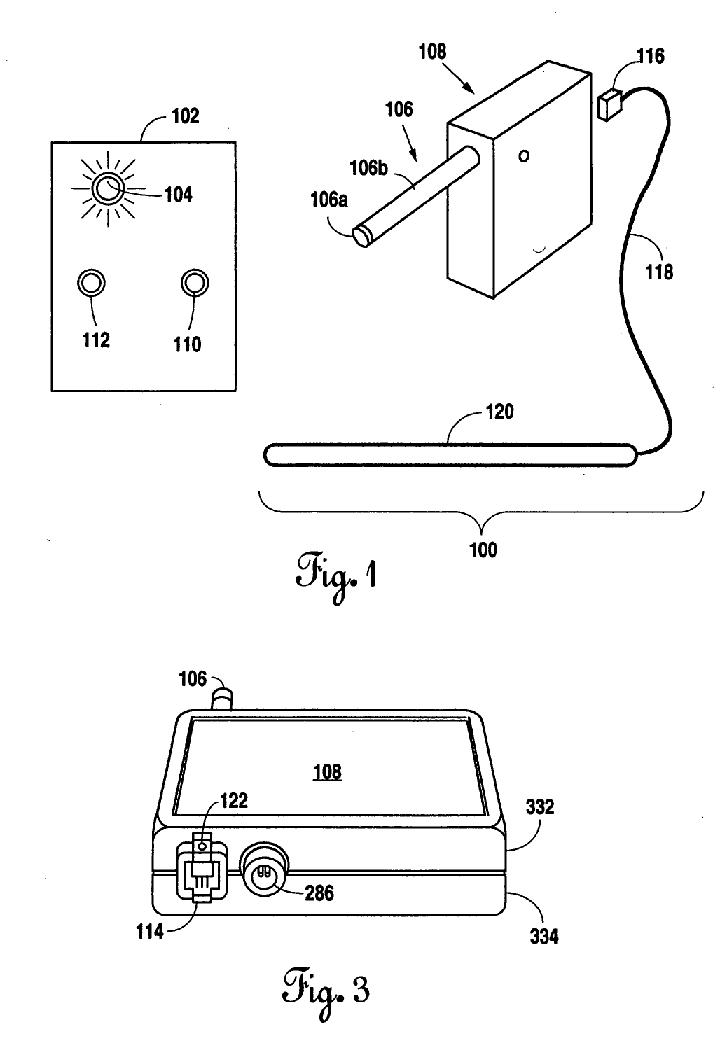

Referring to FIG. 1, a diagrammatic view of the preferred embodiment of the nurse call interface system 100 of the present invention is shown in relation to a nurse call box wall plate 102. A nurse call box wall plate 102 is provided that is standard in the industry. The nurse call box wall plate 102 is designed to be attached to the wall in a patient's or resident's room. Nurse call box wall plate 102 has a signaling lamp 104 that lights up when an alarm signal has been sent. When an alarm signal is sent to the nurse call box wall plate 102 from the nurse call interface 108 through nurse call interface plug 106, the circuit within the nurse call box wall plate 102 is closed. When the circuit to the nurse call box wall plate 102 is closed the signaling lamp 104 will light up inside the patient room. While the circuit to the nurse call box wall plate 102 remains open, signaling lamp 104 does not light up.

Nurse call box wall plate 102 has a nurse call interface opening 110 that is designed to accept nurse call interface plug 106 from nurse call interface 108. Nurse call box wall plate 102 may have additional openings 112 to accommodate additional plugs (not shown).

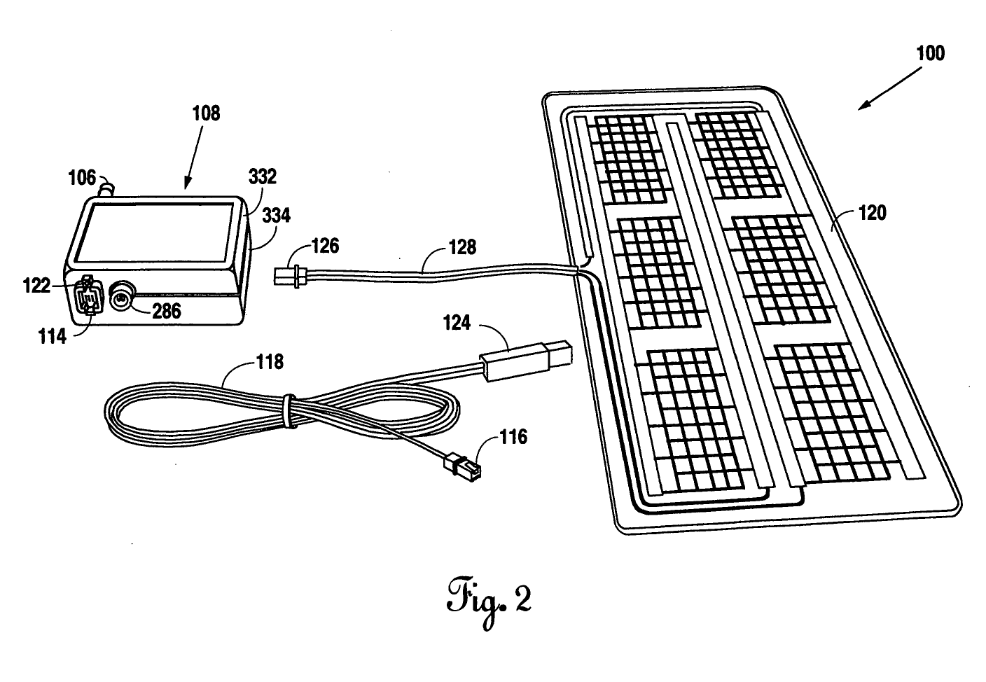

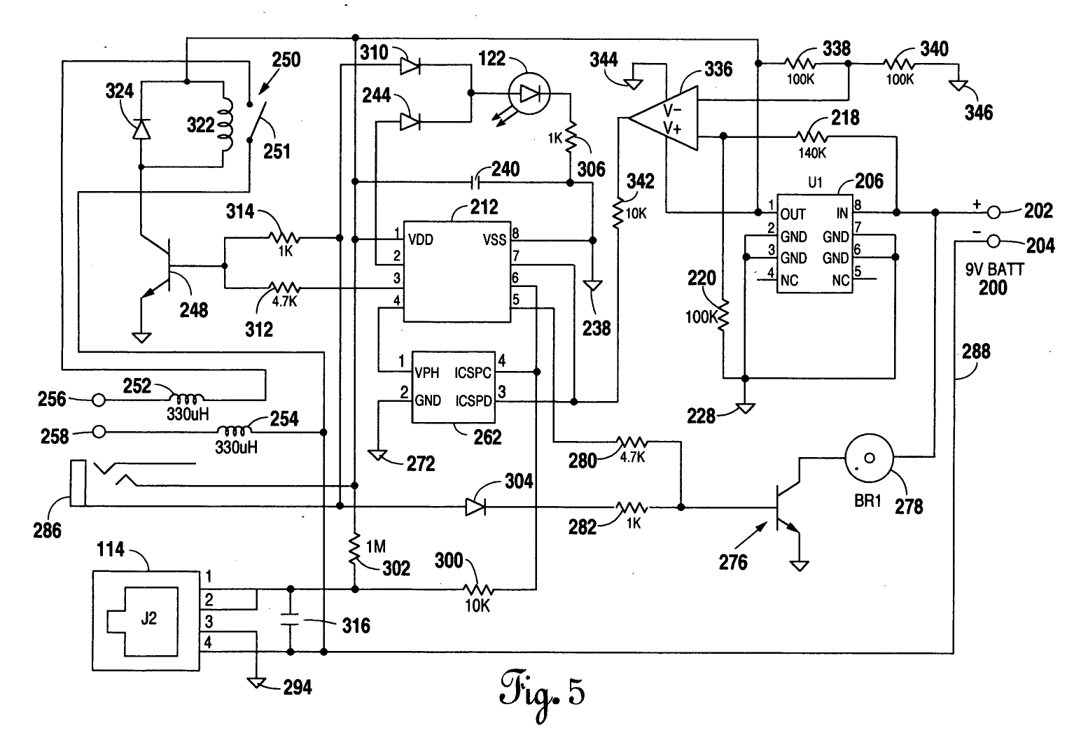

Shown adjacent to nurse call box wall plate 102 is nurse call interface 108 that incorporates nurse call interface plug 106 at its front. Nurse call interface plug 106 is a ¼ inch phone plug that recognizes a contact closure between the tip 106a and sleeve 106b of the plug, such a contact closure can be from a push button from a patient's bed or from a relay 250 (See FIG. 5). At the rear of nurse call interface 108 is a jack 114 (See FIG. 2) which is designed to accept a standard telephone connector plug or RJ9 connector plug 116. While a RJ9 connector plug is specifically discussed in the preferred embodiment, any appropriate sized connector and corresponding jack 114 (See FIG. 2) on the nurse call interface 108 can be used.

The RJ9 connector plug 116 is a four position, four conductor connector plug. The RJ9 connector plug 116 is attached to a cable 118. Cable 118 carries a voltage of 5V. The cable 118 connects the RJ9 connector plug 116 to the sensor pad 120.

FIG. 2 is a perspective view of the components of the preferred embodiment of the nurse call interface system 100 of the present invention. Nurse call interface 108 is provided that incorporates nurse call interface plug 106 at its front. At the rear of nurse call interface 108 is jack 114 which is designed to accept a standard telephone connector plug or RJ9 connector plug 116. Located next to jack 114 is opening 286 which is designed to accept a nurse call button system (not shown). Positioned next to jack 114 is a LED light 122 to notify the user that the nurse call interface 108 is turned on and working. In the preferred embodiment, the LED light 122 turns on for 200 milliseconds and turns off for 5 seconds; however, any flashing sequence could be used. The in-use LED is green.

The RJ9 connector plug 116 is attached to a cable 118. Cable 118 carries a voltage of 5V. The cable 118 connects the RJ9 connector plug 116 to the sensor pad 120 by way of a first part of a three pin Molex connector 124 on the cable 118 and a corresponding mating part of the three pin Molex connector 126 on the sensor pad 120. The mating part of the three pin Molex connector 126 is connected to sensor pad 120 by way of an electrical strip 128. While a three pin Molex connector is specifically discussed in the preferred embodiment, any appropriate sized connector and corresponding opening on the sensor pad 120 can be used.

In FIG. 3 a back view of the preferred embodiment of the nurse call interface 108 of the present invention is shown. Nurse call interface 108 incorporates nurse call interface plug 106 at its front and jack 114 at its rear. Located next to jack 114 is opening 286 which is designed to accept a nurse call button system (not shown). Positioned next to jack 114 is a LED light 122. Nurse call interface 108 consists of a top portion 332 and a bottom portion 334. Housed within the top portion 332 and bottom portion 334 is an electrical assembly (See FIG. 5) that is responsible for the operation of the nurse call interface 108.

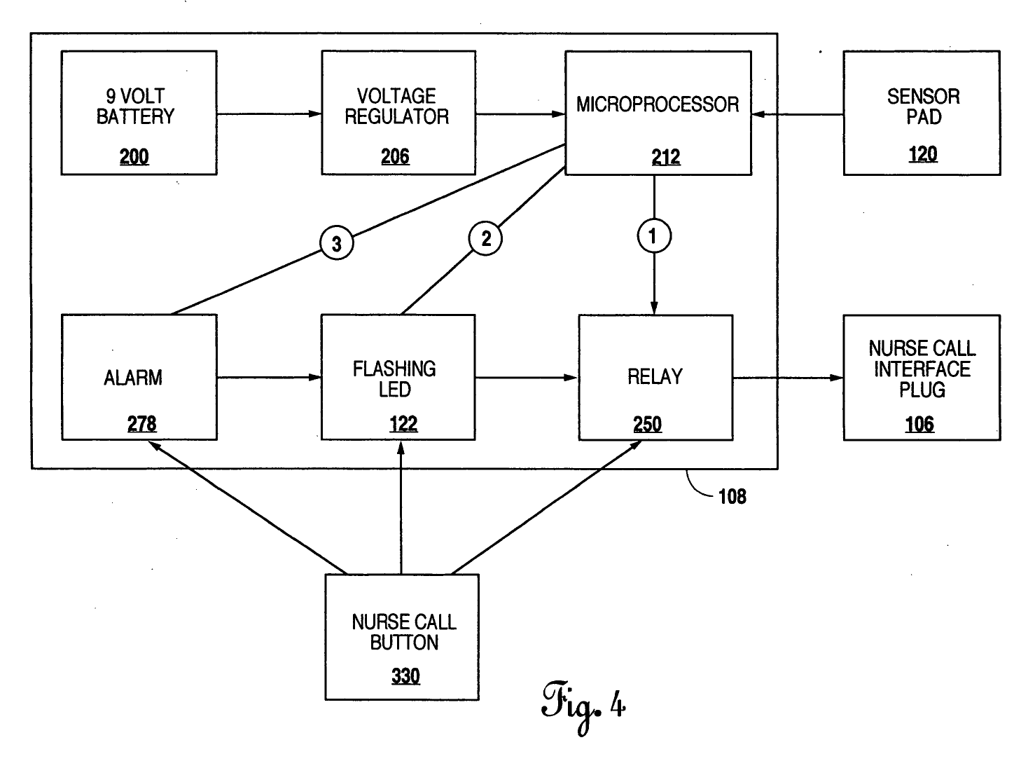

FIG. 4 is a block diagram of the electrical schematic of the electrical assembly for the preferred embodiment of the nurse call interface 108. The electrical assembly is powered by a 9V battery 200, but the voltage from the 9V battery 200 is regulated by voltage regulator 206. When the nurse call interface 108 is plugged into nurse call box wall plate 102, the nurse call interface 108 is in standby mode. When sensor pad 120 is plugged into the nurse call interface 108, the nurse call interface 108 turns on. The nurse call interface 108 will sense a short circuit at pin 3 and pin 4 (See FIG. 5). Once the nurse call interface 108 powers up, the microprocessor 212 sends a signal to LED 122 to indicate the power is on and the nurse call interface 108 is working. Once the microprocessor 212 is powered on, it senses voltage from the sensor pad 120. If this voltage rises above 2.5 volts, such as when the patient or resident no longer puts weight on the sensor pad 120, the microprocessor 212 sends a signal through relay 250 at step 1 to the nurse call interface plug 106 where it is ultimately sent to the nurse call station. In addition, the microprocessor 212 sends a signal (a) to LED 122 at step 2 to actuate LED 122 and (b) to alarm 278 at step 3 to actuate alarm 278. Alarm 278 has a sound level of 75 db at 2 feet. When the sensor pad 120 is actuated by weight thereon, the voltage sensed by microprocessor 212 is below 2.5 volts and no signal is sent to the nurse call interface plug 106 because relay 250 is now not energized.

If the nurse call button 330 is depressed by the patient or resident, a signal is sent to the alarm 278 to actuate alarm 278 and to the LED 122 to actuate LED 122. In addition, a signal is sent to the relay 250 which is then transmitted to the nurse call interface plug 106 where it is ultimately passed to the nurse call station (not shown). When nurse call button 330 is not depressed, no signal is sent.

The nurse call interface 108 defaults to a closed circuit if the 9V battery 200 drops below 5.8 volts. If the 9V battery 200 voltage drops below 5.8 volts, the low voltage comparator 336 sends a signal to the microprocessor 212 which sends a signal to the alarm 278 to actuate the alarm 278 and to the LED 122 to actuate the LED 122. In addition, a signal is sent to the relay 250 which is transmitted to the nurse call interface plug 106. This signal is ultimately sent to the nurse call station. While the 9V battery 200 voltage remains above 5.8V, no signal is sent.

In FIG. 5 a detailed electrical schematic of the electrical assembly of the preferred embodiment of the nurse call interface 108 of the present invention is shown. Within nurse call interface 108 is a 9V battery 200 which provides power to the nurse call interface 108. E1 contact 202 and E2 contact 204 have pigtail leads which connect to 9V battery 200. Connected to 9V battery 200 is a voltage regulator 206. Voltage regulator 206 is low power and converts the 9V from the 9V battery 200 to a steady 5 volts which is used to supply the remaining components of the nurse call interface 108. The output voltage from voltage regulator 206 next passes through a low voltage comparator 336 which is grounded at 344. Positive terminal of low voltage comparator 336 is connected to resistors 338 and 340 terminating in a common tie ground 346. Low voltage comparator 336 compares the 9V battery 200 input to an internal reference voltage. When the voltage at the low voltage comparator 336 falls below the reference voltage this information is communicated to the microprocessor 212. Pin 4 of the low voltage comparator 336 is connected to pin 7 of the microprocessor 212 to communicate the information that the 9V battery 200 has reached the end of its life and should be replaced. Resistor 342 is connected between voltage comparator 336 and microprocessor 212. When the 9V battery 200 has reached this predefined lower voltage level, the LED light 122 flashes and an alarm 278 sounds. In addition, a signal is sent to relay 250 which is transmitted to nurse call interface plug 106. While 9V battery 200 voltage remains above 5.8 volts, no signal is sent to nurse call interface plug 106.

Value and Maximum Tolerance of Component Parts

| Part # | Value | | Maximum Tolerance |
|---|---|---|---|
| 218 | 140 | K | 1% |
| 220 | 100 | K | 5% |
| 240 | 0.1 μF 50 V | | 10% |
| 252 | 330 | μH | 10% |
| 254 | 330 | μH | 10% |
| 312 | 4.7 | K | 5% |
| 314 | 1 | K | 5% |
| 280 | 4.7 | K | 5% |
| 282 | 1 | K | 5% |
| 300 | 10 | K | 5% |
| 316 | 0.1 μF 50 V | | 10% |
| 302 | 1 | M | 5% |
| 306 | 1 | K | 5% |
| 338 | 100 | K | 5% |
| 340 | 100 | K | 5% |
| 342 | 10 | K | 5% |

Pin 1 carries the 5 volts from voltage regulator 206 out to the remainder of the nurse call interface 108. Resistors 218 and 220 set the low voltage set point for the low voltage comparator 336. Pins 2, 3, 6 and 7 are grounded for proper performance.

For the microprocessor 212, pin 1, designated VDD, supplies 5 volts to the microprocessor 212. Pin 8, designated Vss, leads to a common tie ground 238. Capacitor 240 is a standard bypass capacitor which provides a low impedance AC path across the circuit to prevent the power from the microprocessor 212 from propagating into the remainder of the electronics for the nurse call interface 108. Pin 2 of the microprocessor 212 is an output from a timer built into the microprocessor 212. The output from pin 2 goes through steering diode 244 to the LED 122. The steering diode 244 prevents the nurse call interface 108 from discharging through the LED 122. If there is current flowing through steering diode 244, i.e. pin 2 goes high, then LED 122 lights up. Resistor 306 is a current limiting resistor for LED 122 which is connected to a common tie ground 308.

Pin 3 of the microprocessor 212 is an output that turns on transistor 248, which causes current flow through coil 322 that closes switch 251 of relay 250. Relay 250 is a normally open, single-pole, single-throw relay. Diode 324 allows for discharge of coil 322 when opening relay switch 251. When a patient or resident exits the sensor pad 120, depresses a nurse call button 330, or the 9V battery 200 drops to a predefined voltage level, relay switch 251 of relay 250 is closed. When switch 251 is closed, contacts 256 and 258 are connected together. These contacts 256 and 258 are located within the nurse call interface plug 106. When nurse call interface plug 106 is plugged into nurse call box wall plate 102 (See FIG. 1), the current through contacts 256 and 258 is transmitted to the nurse call box wall plate 102 (See FIG. 1). Inductors 252 and 254 located along the line are used to control electrostatic discharges (ESDs). Transistor 248 has resistors 312 and 314 connected to the base which are necessary to limit the base current in transistor 248.

Pin 4 of microprocessor 212 is part of the programming system for microprocessor 212. Pin 4 of microprocessor 212 receives programming code information from pin 1 of connector 262. Connector 262 has the ability to use existing code or accept new code to use in the system. Pin 1, designated VPP, is the power supply for the program. Pin 4 of connector 262, designated ICSPC, is an in-circuit serial programming clock input. Pin 3 of connector 262, designated ICSPD, is an in-circuit serial programming data I/O. Pin 2 of connector 262, designated GND, is a ground leading to a common tie ground 272.

Pin 5 of microprocessor 212 is an output which connects to the base of transistor 276. Transistor 276 has two base resistors 280 and 282 to limit the base current of the transistor 276. Transistor 276 is connected to alarm 278 and can turn alarm 278 on which emits an audible tone. The current to alarm 278 is amplified by transistor 276.

Pin 6 of microprocessor 212 is responsible for receiving input from sensor pad 120 through pin 1 of jack 114. Lead 288 connects 9V battery 200 at 204 to pin 4 of jack 114. When sensor pad 120 is plugged into jack 114 via RJ9 connector plug 116, the nurse call interface 108 automatically turns on. Pin 3 of jack 114 connects 9V battery 200 to a common tie ground 294. There is a short between pin 3 and pin 4 of jack 114 to ground 294. When this short is transmitted, the nurse interface system 108 begins operating. Pin 1 and pin 2 of jack 114 sense a reduction in resistance whenever the sensor pad 120 is depressed by current flow through resistor 300, which is connected to input pin 6 of microprocessor 212. Resistor 300 provides isolation for pin 6 of microprocessor 212 when new code is being loaded into connector 262. Capacitor 316 smooths out the signals received at pin 1 of jack 114.

Referring to FIG. 4, once the nurse call interface 108 powers up, the microprocessor 212 sends a signal to LED 122 to indicate the power is on and the nurse call interface 108 is working. Once the microprocessor 212 is powered on, it senses voltage from the sensor pad 120. If this voltage rises above 2.5 volts, such as when the patient or resident removes their weight from the sensor pad 120, the microprocessor 212 sends a signal through relay 250 to the nurse call interface plug 106 where it is ultimately sent to the nurse call station. In addition, the microprocessor 212 sends a signal to LED 122 to actuate LED 122 and alarm 278 to actuate alarm 278. When the patient's weight is on the sensor pad 120, the voltage sensed by microprocessor 212 will be below 2.5 volts and no signal is sent to the nurse call interface plug 106.

The patient or resident typically has a nurse call button system (not shown) in the bed with him or her. The nurse call button system (not shown) typically consists of a nurse call button 330 and a cable (not shown) with the cable (not shown) being attached to the nurse call box wall plate 102. That nurse call button 330 could be plugged into opening 286 of FIG. 2 or in the additional opening 112 (see FIG. 1). When the nurse call button 330 is depressed by the patient or resident, current flows through the coil 322 of relay 250 causing relay switch 251 to close. In this manner, the patient has the ability to call the nurse without removing weight on the sensor pad 120. In addition, when the nurse call button 330 is depressed by the patient or resident, steering diode 304 causes alarm 278 to turn on and emit an audible tone. Further, the current from opening 286 goes through steering diode 310 to LED 122. The steering diode 310 prevents the nurse call interface 108 from discharging through the LED 122. If there is current flowing through steering diode 310 then LED 122 lights up. When the nurse call button 330 is not depressed, no signal is sent through opening 286.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A nurse call interface system for sensing if a patient is no longer in a predetermined position to signal a nurse through a nurse call box, said nurse call interface system comprising:
a sensor pad for positioning below said patient to receive weight of said patient thereon;
sensor pad connections for connecting said sensor pad to a nurse call interface;
said nurse call interface including:
a source of power for said nurse call interface, said source of power feeding through said sensor pad connections to said sensor pad;
a microprocessor in said nurse call interface for receiving a loss of weight signal from said sensor pad via said sensor pad connections if weight of said patient is no longer on said sensor pad;
first warning signal being generated by said microprocessor upon receiving said loss of weight signal, said first warning signal being sent via a nurse call interface plug in said nurse call box to said nurse;
said microprocessor also allowing for a second warning signal from a nurse call button connecting therethrough via said nurse call interface plug and said nurse call box to said nurse;
said nurse call interface being constructed so that said first warning signal and said second warning signal will not interfere with each other.

2. The nurse call interface system for sensing if said patient is no longer in a predetermined position as recited in claim 1 wherein said nurse call interface includes a voltage regulator between said source of power and said microprocessor to maintain at least a predetermined voltage level at said microprocessor, said microprocessor generating said first warning signal if said predetermined voltage level is not maintained.

3. The nurse call interface system for sensing if said patient is no longer in a predetermined position as recited in claim 2 further including a light that is turned on by said microprocessor when said nurse call interface system is operating.

4. The nurse call interface system for sensing if said patient is no longer in a predetermined position as recited in claim 3 further comprising a connector for loading and updating code connected to said microprocessor

5. The nurse call interface system for sensing if said patient is no longer in a predetermined position as recited in claim 4 further comprising a jack for receiving input from said nurse call button.

6. The nurse call interface system for sensing if said patient is no longer in a predetermined position as recited in claim 5 wherein said jack has at least two pins that reduce the resistance through a connected resistor when said sensor pad is depressed.

7. The nurse call interface system for sensing if said patient is no longer in a predetermined position as recited in claim 6 wherein said jack has at least 2 pins that maintain a short therethrough, whereby when said short occurs said nurse call interface begins operating.

8. The nurse call interface system for sensing if said patient is no longer in a predetermined position as recited in claim 7 wherein said microprocessor has a capacitor to prevent power of said microprocessor from propagating into the remainder of said nurse call interface.

9. A method for sensing and signaling if a patient is no longer in a predetermined position of a bed in connection with a nurse call box, comprising the steps of:
positioning a sensor pad below said patient to receive weight of said patient thereon;
connecting said sensor pad to a nurse call interface;
providing power to said sensor pad and said nurse call interface with a power source;
sending a loss of weight signal from said sensor pad to a microprocessor if weight of said patient is no longer on said sensor pad;
generating a first warning signal upon receipt by said microprocessor of said loss of weight signal;
second sending said first warning signal via a nurse call interface plug to a nurse;
second generating a second warning signal upon receipt by said microprocessor of a signal from a nurse call button; and
third sending said second warning signal via said nurse call interface plug to said nurse;
wherein said first warning signal and said second warning signal do not interfere with each other.

10. The method for sensing and signaling if a patient is no longer in a predetermined position of a bed in connection with a nurse call box of claim 9 further comprising maintaining a predetermined voltage level at said microprocessor, said microprocessor generating said first warning signal if said predetermined voltage level is not maintained.

11. The method for sensing and signaling if a patient is no longer in a predetermined position of a bed in connection with a nurse call box of claim 10 further comprising loading and updating code for said microprocessor.

12. The method for sensing and signaling if a patient is no longer in a predetermined position of a bed in connection with a nurse call box of claim 11 wherein said sending step further comprises the step of said microprocessor sensing the voltage from a resistor in the connection from said sensor pad.

13. The method for sensing and signaling if a patient is no longer in a predetermined position of a bed in connection with a nurse call box of claim 12 wherein said sending step occurs when the voltage sensed by said microprocessor from said resistor rises above a first predetermined value.

14. The method for sensing and signaling if a patient is no longer in a predetermined position of a bed in connection with a nurse call box of claim 13 wherein said first predetermined value is 2.5 volts.

15. The method for sensing and signaling if a patient is no longer in a predetermined position of a bed in connection with a nurse call box of claim 14 wherein said second generating step further comprises the step of said microprocessor sensing a voltage in the connection from said nurse call button.

16. The method for sensing and signaling if a patient is no longer in a predetermined position of a bed in connection with a nurse call box of claim 15 further comprising regulating the voltage in the connection from said power source.

17. The method for sensing and signaling if a patient is no longer in a predetermined position of a bed in connection with a nurse call box of claim 16 further comprising the step of transmitting a signal from a voltage comparator to said microprocessor when the voltage sensed by said voltage comparator from said power supply drops below a second predetermined value.

18. The method for sensing and signaling if a patient is no longer in a predetermined position of a bed in connection with a nurse call box of claim 17 wherein said second predetermined value is 5.8 volts.
